(19) United States
(12) Patent Application Publication
(10) Pub. No.: US 2023/0040163 A1
(43) Pub. Date: Feb. 9, 2023

(54) SYSTEMS AND METHODS FOR PROCESSING INTELLIGENCE OF USERS CAPTURED THROUGH QUANTITATIVE DATA COLLECTION

(71) Applicant: JPMORGAN CHASE BANK, N.A., New York, NY (US)

(72) Inventors: Jeremy Miles WILLIAMS, Delaware, OH (US); Adam Michael LEVINE, Wilmington, DE (US); Paul BUENAVENTURA, New York, NY (US); Derek BLAZO, Westervlle, OH (US); Paul D MAGASINY, Kennett Square, PA (US)

(21) Appl. No.: 17/818,125

(22) Filed: Aug. 8, 2022

Related U.S. Application Data
(60) Provisional application No. 63/230,994, filed on Aug. 9, 2021.

(51) Int. Cl. G06Q 10/06

(52) U.S. Cl. CPC G06Q 10/0635

(57) ABSTRACT

Systems and methods for processing intelligence of users captured through quantitative data collection are disclosed. In one embodiment, a method for processing intelligence captured through quantitative data collection may include: (1) receiving, by a data management computer program executed by a computer processor, user interaction data from an agent executed by a user electronic device; (2) determining, by the data management computer program and from the user interaction data, a path in a process being taken by a user of the user electronic device; (3) comparing, by the data management computer program, the path to an approved path; (4) identifying, by the data management computer program, a difference between the path and the approved path; (5) determining, by the data management computer program, an impact of the difference; and (6) outputting, by the data management computer program, the difference and the impact.

### RELATED APPLICATIONS

This application claims priority to, and the benefit of, U.S. Provisional Patent Application Ser. No. 63/230,994, filed Aug. 9, 2021, the disclosure of which is hereby incorporated, by reference, in its entirety.

### BACKGROUND OF THE INVENTION

### 1. Field of the Invention

Embodiments generally relate to systems and methods for processing intelligence of users captured through quantitative data collection.

### 2. Description of the Related Art

Presently, businesses are unable to see real-time or near real-time how users, such as employees, are performing and completing work today, or to determine if associates are adhering to the set/approved standard and how they are deviating.

### SUMMARY OF THE INVENTION

Systems and methods for processing intelligence of users captured through quantitative data collection are disclosed. In one embodiment, a method for processing intelligence captured through quantitative data collection may include: (1) receiving, by a data management computer program executed by a computer processor, user interaction data from an agent executed by a user electronic device; (2) determining, by the data management computer program and from the user interaction data, a path in a process being taken by a user of the user electronic device; (3) comparing, by the data management computer program, the path to an approved path; (4) identifying, by the data management computer program, a difference between the path and the approved path; (5) determining, by the data management computer program, an impact of the difference; and (6) outputting, by the data management computer program, the difference and the impact.

In one embodiment, the user interaction data may be further collected by an image capture device.

In one embodiment, the user interaction data may include keystrokes, mouse movements, clicks, user focal points on a display of the user electronic device, etc.

In one embodiment, the path may be determined based on a series of actions in the user interaction data.

In one embodiment, the impact may include wasted time, unnecessary actions, mistakes, and/or exposure to risk.

In one embodiment, the method may also include providing, by the data management computer program, feedback to the user electronic device. The feedback may include presenting a suggested next step.

In one embodiment, the method may also include preventing, by the data management computer program, execution of a next step based on a high exposure to risk.

According to another embodiment, a system may include a user electronic device comprising a computer process and executing an agent that captures user interaction data and an electronic device comprising a data management computer program. The agent may receive the user interaction data and communicates the user interaction data to the data computer management program. The management computer program may determine a path in a process being taken by a user of the user electronic device from the user interaction data, may compare the path to an approved path, may identify a difference between the path and the approved path, may determine an impact of the difference, and may output the difference and the impact.

In one embodiment, the system may also include an image capture device that further captures the user interaction data.

In one embodiment, the user interaction data may include keystrokes, mouse movements, clicks, user focal points on a display of the user electronic device, etc.

In one embodiment, the path may be determined based on a series of actions in the user interaction data.

In one embodiment, the impact may include wasted time, unnecessary actions, mistakes, and/or exposure to risk.

In one embodiment, the data management computer program may provide feedback to the user electronic device. The feedback may include presenting a suggested next step.

In one embodiment, the data management computer program may prevent execution of a next step based on a high exposure to risk.

According to another embodiment, a non-transitory computer readable storage medium may include instructions stored thereon, which when read and executed by one or more computer processors, cause the one or more computer processors to perform steps comprising: receiving user interaction data from an agent executed on a user electronic device, wherein the user interaction data comprises keystrokes, mouse movements, and clicks; determining a path in a process being taken by a user of the user electronic device from the user interaction data, wherein the path is determined based on a series of actions in the user interaction data; comparing the path to an approved path; identifying a difference between the path and the approved path; determining an impact of the difference, wherein the impact comprises wasted time, unnecessary actions, mistakes, and/or exposure to risk; and outputting the difference and the impact.

In one embodiment, the non-transitory computer readable storage medium may also include instructions stored thereon, which when read and executed by one or more computer processors, cause the one or more computer processors to prevent execution of a next step based on a high exposure to risk.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for processing intelligence of users captured through quantitative data collection is disclosed according to an embodiment.

FIG. 2 depicts a method for processing intelligence of users captured through quantitative data collection according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for processing intelligence of users captured through quantitative data collection.

Embodiments may use computer vision and/or machine learning to capture click-level actions taken by users, such as employees, and document end-to-end processes. For example, embodiments may use data collector bots placed on users' desktops to watch and capture click-level actions while the bot is engaged. Machine learning algorithms, neural networks, and other advanced mathematics may translate the captured actions into business processes, including process variations and data showing suitability for automation. Outputs may include process data (including handle times) and process maps, recommendations for automation, and screenshots of every process step.

Embodiments may need only limited resources to configure and engage desktop collector bots for specific teams or processes.

Embodiments may be used to identify processes to automate, may provide automated process requirements, such as for bot building, etc., and may perform quality assurance on existing bots.

Embodiments may further provide process documentation, monitor processes (e.g., measurements), etc.

Embodiments may create bots using at least some of the output, above. Embodiments may further manage the bots for guided automation.

Embodiments may provide process and quality measurements, including for product journeys, employee productivity, process improvement, business planning and analysis, feeding of machine learning models, neural networks, and other models, auto-generation of standard operating procedure (SOP) documentation, etc. Embodiments may identify system enhancement opportunities and may provide quality assurance (QA) and/or quality control (QC) controls. Embodiments may further monitor controls for compliance.

In embodiments, a hybrid of process mining and process discovery that uses advanced/enhanced computer vision, coupled with machine learning and neural networks, may identify end-to-end processes real-time or near-real-time. Masking of certain data, such as personal information, may be invoked or revoked pending the use and need of the data for analysis is disclosed.

For example, the mining may provide the full view of a widget, how it moves from inception to completion across all systems, and may detail area of bottlenecks/throughput constraints/waste in the process. The outputs may include Business Process Modeling Notation (BPMN)-ready process maps inclusive of data captured, as-is process maps, recommended to-be process maps, etc.; Business Requirement Documentation (BRD) with “why” a process was done, an example of completed process happy path and variants; data files that may be consumed for modeling; etc.

In embodiments, discovery may capture detailed click-level actions, logging, and data input to synthesize the why and frequency of paths taken. Embodiments may detail the “happy path” (e.g., preferred path) and variants of the process. Embodiments may detail the differences in variants and provide recommendations on how to remove variation/waste in the process.

In embodiments, mining and discovery may output key performance indicators (KPIs) in a standard format/toolkit that may be configurable and allow for new widgets to be added. Mining and discovery may provide the recommended path that a certain percentage of processes follow.

After an approved, audit ready path is set, embodiments may measure real-time adherence to that process (and approved variants) and may identify quality issues as work is completed.

Embodiments may provide dashboarding for process mining and discovery, including a view of all variants, a percent of time variants occur with associated volumes, suggestions of how variants are used and how to remove waste in the process, the ability to update “to-be” and “as-is” process for corrective purposes, process flows with simulation capability as variants are selected, system identification and usage, handle times that are dynamic as factors are selected, user identification/assignment as they are associated with a captured process, chokepoints within a process, etc. In addition, embodiments may provide real time and +24 hr updated measures via multiple channels and devices (e.g., mobile, desktop, “big screen,” etc.). Reporting may be interactive and may provide the ability to drill down to the analyst/associate level. The hierarchy of data captured may be grouped into teams and managed at a cost center to provide executive level detail. Data may be historical, real-time, and provides forecasted trending.

Embodiments may provide visualization for analysis and training. For example, the detailed “happy path” and variants of the process may be displayed in an interactive format for the user to view the process actions taken, and differences between the variants, as well as recommendations on how to remove variation/waste in the process. Further, embodiments may provide a simulation of paths taken with metrics that support a percentage of the paths taken. For each simulation, relative quantitative data (e.g., the applications used, the handle time, the users, the volume, service level agreement adherence, etc.) may be displayed and dynamically updated based on path chosen.

In embodiments, predictive volumes by process type based on historical captured trends may be provided.

Examples of data displayed may include: Service Level Agreement (SLA) adherence; average handle time; handle times by associate, team, group, function, product type, etc.; predictive volumes by team, group, function, product type, etc., adherence to the approved standard work (e.g., real-time and historical trends); through machine learning, neuro-networking, and/or other advanced mathematics, identify trends and alerts as to how/why items are being processed; system usage, percentage of usage for the process and if a new application is introduced into the ecosystem; etc. Embodiments may alert users when a process is deviating and may require updates to the standard work/audit ready process.

Embodiments may provide at least some of the following technical advantages: measure and visually display a view of process performance, including baseline process, approved variants, non-conforming variants, real time variation, etc.; alerting (e.g., identifying a significant shift or trend and presenting it for review); predictive staffing models; process improvement; business planning and analysis, identification of system enhancement opportunities; controls (e.g., QA, QC, Compliance), etc.

Embodiments may be used with high-risk activities, such as money wiring, in which discipline to a standard process is required. If the user deviates from the standard process, embodiments may alert the user, supervisors, etc. The alert may be in real-time. Embodiments may require manual override to continue with a process that deviates from the standard.

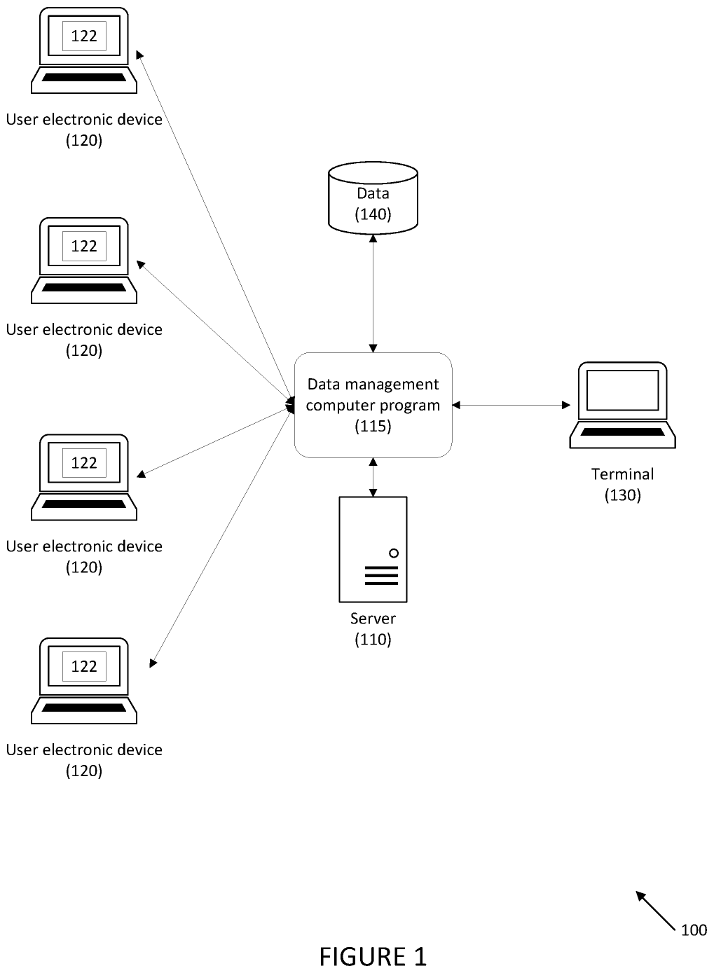

Referring to FIG. 1, a system for processing intelligence of frontline associates captured through quantitative data collection is disclosed according to an embodiment. System 100 may include electronic device 110, which may be any suitable electronic device, including servers (e.g., physical servers, cloud-based servers, combinations thereof), computers (e.g., workstations, desktop, laptop, tablet), smart devices, Internet of Things appliances, etc. Electronic device 110 may execute data management computer program 115, which may receive and process user interaction data from user electronic devices 120.

User electronic devices 120 may be any suitable electronic device, including workstations, desktop computers, laptop/notebook computers, tablet computers, smart devices, Internet of Things (IoT) devices, etc. Each user electronic device 120 may execute an agent or program 122 that may collect user interaction data, such as keystrokes, mouse movements or activities, times spent on certain activities, etc. In one embodiment, user electronic device 120 may include an image capture device (not shown) that may capture user eye data that may be used to detect eye focal points on a screen of user electronic device 120.

System 100 may further include terminal 130 that may provide output of data management computer program 115.

System 100 may further include database 140 that may store user interaction data, reports, etc. In one embodiment, database 140 may be a distributed ledger, such as a blockchain-based ledger.

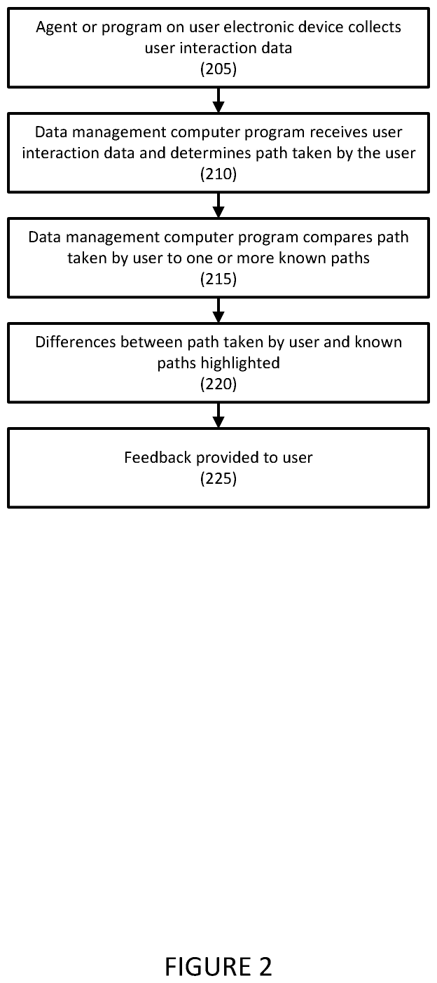

Referring to FIG. 2, a method for processing intelligence of frontline associates captured through quantitative data collection is disclosed according to an embodiment.

In step 205, an agent or program on a user electronic device may collect user interaction data, such as keystrokes, mouse movements, “clicks,” hovers, time spent on activities, focal points, etc.

In one embodiment, the user interaction data may be captured using an image capture device, such as a camera or other device.

In one embodiment, the process may be identified by manual identification, by monitoring the user's actions, etc. For example, the user interaction data may indicate a path taken in a process.

In step 210, a data management computer program may receive the user interaction data and may determine a path in a process that is being performed by the user. For example, the data management computer program may identify multiple points in the process, such as actions (e.g., user selections) from the user interaction data. In one embodiment, the path may be identified based on a starting point, the user's job requirements, a previous action taken, etc.

In step 215, the data management computer program may compare the path taken by the user to one or more known process paths. For example, the path taken by the user may be compared to one or more preferred or “happy path,” that the user is recommended or required to take. The preferred path may be the path that the user is trained to take.

More than one preferred path may be provided. For example, the preferred path(s) may be based on the patterns used by users. The data management computer program may identify the frequency of any variations in these patterns.

In another embodiment, the path taken by the user may be compared to paths taken by other users.

In step 220, the data management computer program may identify any differences identified in the comparison may be identified, and may determine the impact. In one embodiment, the impact may be in wasted time or actions, potential or actual mistakes, exposure to risk, etc. In one embodiment, any analysis for the differences may be presented, along with the user interaction data associated with the difference, to a supervisor or manager. The output may provide a visual depiction of process performance, including baseline process, approved variants, non-conforming variants, real time variation, etc.

In one embodiment, the path taken by the user may be compared to existing paths to see if it is more efficient. If it is, the preferred path may be updated.

In step 225, data management computer program may provide feedback to the user. In one embodiment, the feedback may be provided in real-time (e.g., if the user is taking a path other than an accepted path, the user may be alerted of such), or may be provided in an after-action review.

In one embodiment, the level of feedback may include presenting a suggestion (e.g., highlighting and/or displaying the action to take) that may be presented concurrently, identifying and providing the next action in the preferred process, requiring confirmation that the user intends to take the step, preventing the user from executing the action without, for example, approval from a supervisor, etc. The level of feedback may depend on the type of actions being taken, the risk involved in taking the action, the experience level of the user, etc.

In one embodiment, the data management computer program may identify the next action by moving or nudging the cursor in a direction associated with the next action in the preferred process, highlighting the next action, providing a voice identification of the next step, etc.

In embodiments, based on the user activities (e.g., what users are doing, the order and times they are doing it, etc.), data management computer program may identify device efficiency of the user device. For example, data management computer program may identify applications that are installed but not being used that may slow the operation of the electronic device by taking up memory and/or CPU cycles. The data management computer program may also to determine inter-relationship mapping between technology systems, and determine real-time compliance validation, etc. In embodiments, data may be used to generate information for real time manager coaching, such as when the users are deviating from a particular process.

In one embodiment, the data may be stored and retrieved for audit purposes.

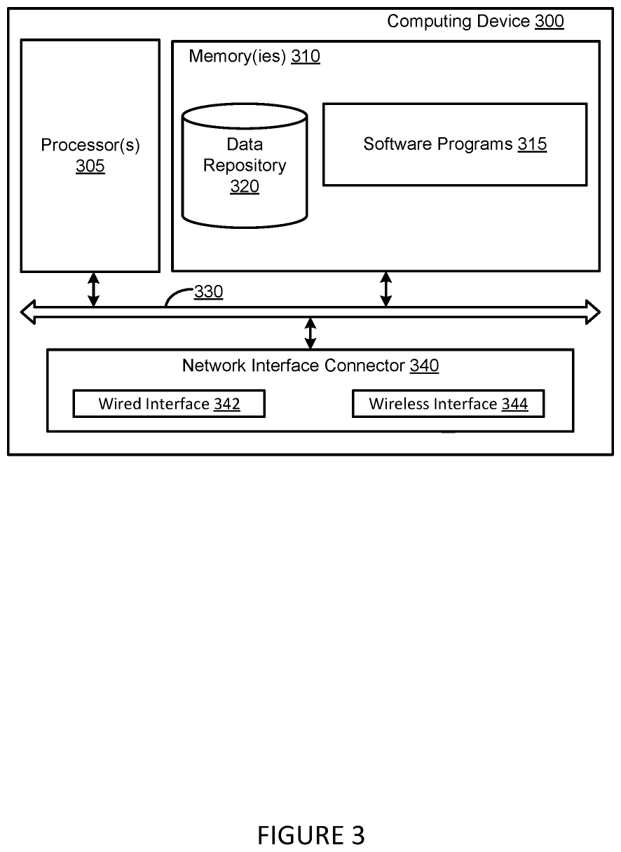

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for processing intelligence captured through quantitative data collection, comprising:
receiving, by a data management computer program executed by a computer processor, user interaction data from an agent executed by a user electronic device;
determining, by the data management computer program and from the user interaction data, a path in a process being taken by a user of the user electronic device;
comparing, by the data management computer program, the path to an approved path;
identifying, by the data management computer program, a difference between the path and the approved path;
determining, by the data management computer program, an impact of the difference; and
outputting, by the data management computer program, the difference and the impact.

2. The method of claim 1, wherein the user interaction data is further collected by an image capture device.

3. The method of claim 1, wherein the user interaction data comprises keystrokes, mouse movements, and clicks.

4. The method of claim 1, wherein the user interaction data comprises user focal points on a display of the user electronic device.

5. The method of claim 1, wherein the path is determined based on a series of actions in the user interaction data.

6. The method of claim 1, wherein the impact comprises wasted time, unnecessary actions, mistakes, and/or exposure to risk.

7. The method of claim 1, further comprising:
providing, by the data management computer program, feedback to the user electronic device.

8. The method of claim 7, wherein the feedback comprises presenting a suggested next step.

9. The method of claim 6, further comprising:
preventing, by the data management computer program, execution of a next step based on a high exposure to risk.

10. A system, comprising:
a user electronic device comprising a computer process and executing an agent that captures user interaction data; and
an electronic device comprising a data management computer program;
wherein:
the agent receives the user interaction data and communicates the user interaction data to the data computer management program;
the data management computer program determines a path in a process being taken by a user of the user electronic device from the user interaction data;
the data management computer program compares the path to an approved path;
the data management computer program identifies a difference between the path and the approved path;
the data management computer program determines an impact of the difference; and
the data management computer program outputs the difference and the impact.

11. The system of claim 10, further comprising an image capture device that further captures the user interaction data.

12. The system of claim 10, wherein the user interaction data comprises keystrokes, mouse movements, and clicks.

13. The system of claim 10, wherein the user interaction data comprises user focal points on a display of the user electronic device.

14. The system of claim 10, wherein the path is determined based on a series of actions in the user interaction data.

15. The system of claim 10, wherein the impact comprises wasted time, unnecessary actions, mistakes, and/or exposure to risk.

16. The system of claim 10, wherein the data management computer program provides feedback to the user electronic device.

17. The system of claim 16, wherein the feedback comprises presenting a suggested next step.

18. The system of claim 15, wherein the data management computer program prevents execution of a next step based on a high exposure to risk.

19. A non-transitory computer readable storage medium, including instructions stored thereon, which when read and executed by one or more computer processors, cause the one or more computer processors to perform steps comprising:
receiving user interaction data from an agent executed on a user electronic device, wherein the user interaction data comprises keystrokes, mouse movements, and clicks;
determining a path in a process being taken by a user of the user electronic device from the user interaction data, wherein the path is determined based on a series of actions in the user interaction data;
comparing the path to an approved path;
identifying a difference between the path and the approved path;
determining an impact of the difference, wherein the impact comprises wasted time, unnecessary actions, mistakes, and/or exposure to risk; and
outputting the difference and the impact.

20. The non-transitory computer readable storage medium of claim 19, further including instructions stored thereon, which when read and executed by one or more computer processors, cause the one or more computer processors to perform steps comprising:
preventing execution of a next step based on a high exposure to risk.
